(19) United States
(12) Patent Application Publication
(10) Pub. No.: US 2015/0089851 A1
(43) Pub. Date: Apr. 2, 2015

(54) CONTENT DISPLAY SYSTEMS

(71) Applicant: Franke Technology and Trademark Ltd., Hergiswil (CH)

(72) Inventor: Ariel H. Minguez, La Canada, CA (US)

(73) Assignee: Franke Technology and Trademark Ltd., Hergiswil (CH)

(21) Appl. No.: 14/499,614

(22) Filed: Sep. 29, 2014

Related U.S. Application Data
(60) Provisional application No. 61/885,308, filed on Oct. 1, 2013.
(60) Provisional application No. 61/891,747, filed on Oct. 16, 2013.

(51) Int. Cl. G09F 7/18; G09F 7/00

(52) U.S. Cl. CPC G09F 7/18; G09F 7/00; G09F 2007/1852
USPC 40/594; 40/607.13; 40/600

(57) ABSTRACT

A content display system is provided having a substrate configured to be temporarily affixed to a surface and a dimensional content component configured to be permanently or semi-permanently affixed to the substrate. The substrate can be configured as a window decal, and a temporary adhesive is arranged on an adhesive surface of the substrate to affix the substrate to the surface. The dimensional content component is configured as a three-dimensional advertisement.

### INCORPORATION BY REFERENCE

The following documents are incorporated herein by reference as if fully set forth: U.S. Provisional Application No. 61/885,308, filed Oct. 1, 2013; and U.S. Provisional Application No. 61/891,747, filed Oct. 16, 2013.

### FIELD OF THE INVENTION

The present invention relates to content display systems for advertising purposes and more particular to dimensional display systems configured to present dimensional content to consumers.

### BACKGROUND OF THE INVENTION

Advertisers are continually striving to create advertising campaigns that stand out and capture the attention of consumers in an increasingly crowded marketplace. For certain retailers, such as restaurants, grocery stores, and clothing retailers, display advertisements are one foundation of their marketing strategy. In general, display advertisements include signs and decals arranged on various surfaces, such as walls or windows, that convey advertising messages. Display advertisements allow retailers to advertise to consumers patronizing their establishments and/or potential consumers in the vicinity. For example, a display advertisement on a window adjacent to a restaurant entrance may be used to inform patrons of new menu items.

However, conventional display advertising is limited because the effectiveness of a sign or decal is often reduced due to the persistent exposure of consumers to such advertisements as well as the number of similar, nearby competing messages. In addition, the messages provided through display advertisements are only able to capture the attention of consumers that are directly or substantially directly in front of the sign or decal. Accordingly, a display advertising system that is able to command attention in today's crowded retail marketplace and is effective at drawing attention from more vantage points would be beneficial to the retail and advertising industries

### SUMMARY OF THE INVENTION

An efficient way to command attention and create an advertising campaign that stands out would be the use of dimensional display systems configured to present dimensional content to consumers. Dimensional content includes at least one multi-dimensional element having at least a portion that extends away from the surface that the content display system is affixed to. The dimensional display content may include three-dimensional (3D) content, such as 3D shapes, text, images, photographs, or the like. In this manner, content display systems configured may operate to stand out from conventional, two-dimensional (2D) display advertisements and effectively engage consumers.

Display systems with dimensional content, particularly when placed outdoors in front of an shop or restaurant, need to be affixed on a surface such as a window or a wall of the shop or restaurant in a way that enables the display system to withstand environmental conditions (for instance, heat, wind, and/or incidental contact) for an adequate period of time.

The placement of dimensional content using conventional techniques generally requires the use of permanent methods and/or materials for affixing the dimensional content on a surface. Permanent methods and/or materials such nails, screws, or other similar fasteners, to permanently affix the dimensional material to a surface are required due to the weight, shape, size, and/or materials required to form a dimensional material. However, nails and screws cannot be used for glass surfaces and require special tools and/or permanent changes to other types of building surfaces, particularly brick and concrete surfaces, which are commonly used for retail structures. Alternatively, strong permanent and/or weatherproof adhesive products may be employed to affix dimensional content to a surface. However, such permanent and/or weatherproof adhesive products require time, materials and labor resources to be completely removed and cleaned from surfaces once the dimensional content is taken down. In addition, the removal of permanent and/or adhesive products may damage surfaces and/or surface coatings.

It is thus an object of the present invention to provide content display systems configured for stable, yet semi-permanent installation on various surfaces and surface coatings.

These and other objects that appear below are achieved by content display system having a substrate and a dimensional content component. The substrate is configured to be temporarily, i.e. removably affixed to a surface, such as a wall, window or other structure of a building and the content component is configured to be permanently or semi-permanently affixed to the substrate. In this manner, and as described in more detail below, the content component may be displayed from a surface without being directly affixed to the surface.

The substrate operates as a carrier for the dimensional content, whereby the dimensional content may be affixed to the substrate layer for display from the surface without having to be directly affixed to the surface. As such, the dimensional content may be affixed using permanent materials without having to apply the permanent materials directly to the surface. The dimensional content may be affixed to the surface through the substrate layer in a semi-permanent yet stable manner.

In particular, the substrate covers a surface area and is affixed thereto, which is considerably larger than a contact area between the dimensional content component and the substrate. Typically, the surface area covered by the substrate is by at least an order of magnitude larger than the contact surface area on which the dimensional content component is affixed to the substrate. Therefore, by covering a large surface area, the substrate provides stable support for the dimensional content component, even though the substrate is easily removable from the surface as such. On the other hand, the connection between the dimensional display component and the substrate can be achieved with strong permanent and weatherproof adhesive products without damaging the underlying surface.

Accordingly, a content component that is unsuitable as such for being affixed to a surface due to characteristics of the content component and/or the surface, such as the size, shape, weight, materials, or the like can be affixed to a surface by forming a substrate that is suitable for being affixed to the surface and affixing the content component to the substrate to display content arranged thereon from the surface.

According to an aspect of the invention, the substrate may be formed of a thin flexible material or film with graphics printed on one side (the “display” side), which is commonly referred to as a “decal” or “window decal”. The thin flexible material or film may be made from various materials including but not limited to various paper products (for example, card stock grade paper) and/or polymers (for example, vinyl and derivatives thereof). A window decal may be affixed to a surface through various methods, such as through a temporary adhesive material on the side opposite the display side (the “adhesion” side) or by forming the window decal from a material that is able to “cling” to one or more types of surfaces (often referred to as a “static cling”). Window decals can also be configured such that the display side and the adhesion side are the same. Preferably, the substrate is made of a thin material that is transparent or at least translucent so that when used as a windows decal, the corresponding window is not completely shaded.

According to another aspect of the invention, a content display system includes a dimensional element having a magnetic backing configured to be affixed to a metallic surface.

According to yet another aspect of the invention, a content display system includes a dimensional element connected to a support attachment, mechanism and/or structure.

### BRIEF DESCRIPTION OF THE DRAWINGS

Embodiments of the present invention will now be described with reference to the accompanying drawings.

FIG. 1 depicts a front view of an illustrative substrate content display system according to some embodiments.

FIGS. 2A and 2B depict a side view of a substrate content display system according to some embodiments.

FIGS. 3A and 3B depict a front view and a back view, respectively, of an illustrative substrate content display system.

FIGS. 4A and 4B depict illustrative magnetic content display systems according to some embodiments.

FIGS. 5A and 5B depict multiple views of an illustrative magnetic content display system according to a first embodiment.

FIGS. 6A and 6B depict multiple views of an illustrative magnetic content display system according to a second embodiment.

FIG. 7 depicts an illustrative magnetic content display system according to a third embodiment.

FIGS. 8A and 8B depict an illustrative support structure content display system according to an embodiment.

FIG. 9 depicts a back view of a support structure content display system according to an embodiment.

### DETAILED DESCRIPTION OF THE PREFERRED EMBODIMENTS

The invention described in this document is not limited to the particular systems, methodologies or protocols described, as these may vary. The terminology used herein is for the purpose of describing particular embodiments only, and is not intended to limit the scope of the present disclosure.

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

The described technology generally relates to content display systems. In some embodiments, a content display system may include a substrate and a content component (a “substrate content display system”). The substrate may be configured to be affixed to a surface, such as a wall, window or other structure of a building and the content component may be configured to be affixed to the substrate. In this manner, and as described in more detail below, the content component may be displayed from a surface without being directly affixed to the surface. For instance, the content component may be unsuitable for being affixed to a surface due to characteristics of the content component and/or the surface, such as the size, shape, weight, materials, or the like. A substrate may be formed that is suitable for being affixed to the surface and the content component may be affixed to the substrate to display content arranged thereon from the surface.

In some embodiments, a content display system may include a dimensional element having a magnetic backing configured to be affixed to a metallic surface (a “magnetic content display system”). In some embodiments, a content display system may include a dimensional element connected to a support attachment, mechanism and/or structure (a “support structure content display system”).

Retailers use various point-of-purchase (POP) signs and decals to communicate information to consumers patronizing their establishments. These POP advertisements are generally semi-permanent (removable) as they are used as part of an advertising campaign with a known lifespan. Accordingly, retailers are continually affixing and removing POP advertisements from various interior and exterior surfaces of their establishments. As such, retailers prefer POP advertisements that may be removed without damaging surfaces and/or leaving behind any material (for example, adhesives) that require extensive time and resources to remove.

“Decals” or “window decals” are common POP advertisements that include a thin flexible material or film with graphics printed on one side (the “display” side). Non-limiting examples of decals or window decals include Fathead® decals produced by Fathead, LLC of Detroit, Mich., United States.

The thin flexible material or film may be made from various paper products (for example, card stock grade paper) and/or polymers (for example, vinyl and derivatives thereof). A window decal may be affixed to a surface through various methods, such as through an adhesive material on the side opposite the display side (the “adhesion” side) or by forming the window decal from a material that is able to “cling” to one or more types of surfaces (often referred to as a “static cling”). Window decals may be used on various surfaces, but are commonly displayed on Windows and other glass surfaces where non-adhesive means of affixing (for example, nails, screws, or the like) are not able to be used. Certain window decals are configured such that the display side and the adhesion side are the same. For example, a window decal may be affixed to the interior of a window for viewing by outside customers. In another example, a window decal may be configured with two display sides, a first display side visible from the interior of a building and the second display side visible from the exterior of a building.

Window decals are generally thin and are only able to provide a two dimensional image. As such, any text or image printed on the window decal may only be viewed by consumers who are in front of or substantially in front of the window decal. Window decals, and other related signage, have become ubiquitous in the retail space, including restaurants, fast-food establishments, clothing retailers, banks, and the like. As such, their effectiveness at attracting consumer attention and, more importantly, conveying a message retained by the consumer is continually decreasing.

Accordingly, some embodiments provide content display systems configured to present dimensional content to consumers. In some embodiments, dimensional content includes at least one multi-dimensional element having at least a portion that extends away from the surface that the content display system is affixed to. The multi-dimensional element may be configured to display content, including images, text, pictures, or the like. In some embodiments, the dimensional display content may include three-dimensional (3D) content, such as 3D shapes, text, images, photographs, or the like. In this manner, content display systems configured according to some embodiments may operate to stand out from conventional, two-dimensional (2D) display advertisements and effectively engage consumers.

The placement of dimensional content using conventional techniques generally requires the use of permanent methods and/or materials for affixing the dimensional content on a surface. Permanent methods and/or materials may be required due to the weight, shape, size, and/or materials required to form a dimensional material. For example, dimensional content may not be attached to, may not be attached for an adequate period of time to, or may be removed by environmental conditions (for instance, heat, wind, and/or incidental contact) from a surface if temporary methods and/or materials are used to affix the dimensional content to the surface. Permanent methods and/or materials may include using nails, screws, or other similar fasteners to permanently affix the dimensional material to a surface. However, nails and screws cannot be used for glass surfaces and require special tools and/or permanent changes to other types of building surfaces, particularly brick and concrete surfaces, which are commonly used for retail structures. In another example, strong permanent and/or weatherproof adhesive products may be employed to affix dimensional content to a surface. However, such permanent and/or weatherproof adhesive products require time, materials and labor resources to be completely removed and cleaned from surfaces once the dimensional content is taken down. In addition, the removal of permanent and/or adhesive products may damage surfaces and/or surface coatings.

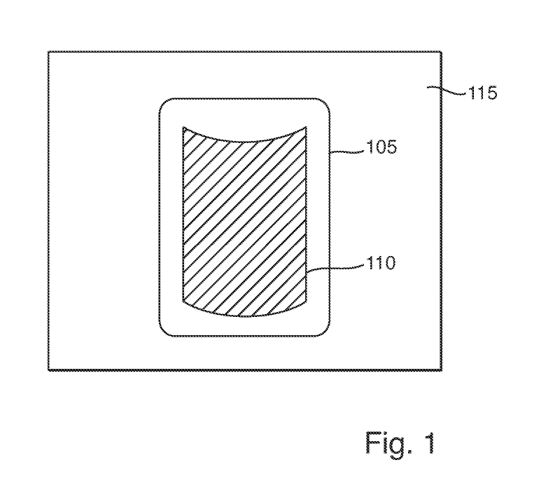

Accordingly, some embodiments provide content display systems configured for stable, yet semi-permanent installation on various surfaces and surface coatings. For instance, FIG. 1 depicts a front view of an illustrative substrate content display system according to some embodiments. As shown in FIG. 1, a substrate content display system may include a substrate layer 105 and dimensional content 110. The substrate layer 105 may be formed from various materials, including, without limitation, paper, plastic, polymers, derivatives thereof, films thereof, and/or combinations thereof. In an embodiment, the substrate layer 105 may be formed from a vinyl material.

In general, the substrate layer 105 may be formed from any material that may be configured to adhere to a surface using temporary methods. Temporary methods may include, without limitation, the use of temporary adhesives or “static cling” for example, as used for conventional window decals. Temporary adhesives may include synthetic acrylic adhesives, for instance, formed from derivatives (for example, esters) of acrylic, methacrylic and/or cyanoacrylic acids. In general, a temporary adhesive may include any adhesive that may be removed from a surface without damaging the surface and/or requiring substantial time, materials and/or labor. A “static cling” may be formed from polyvinyl chloride, including polyvinyl chloride and plasticizers. The static cling may include an adhesive layer formed from temporary adhesives, for example, one or more of the temporary adhesives described herein. The polyvinyl chloride may be formed to have a smooth finish that will cling to a surface without having to directly apply an adhesive material to the surface.

The substrate layer 105 may be affixed to a surface 115. Surfaces may include, without limitation, glass, wood, brick, drywall, fabric, plastic, concrete, and paper. A surface may be at least partially coated by a coating including, without limitation, paint, paint primer, glass tinting material, and wallpaper. The dimensional content 110 may be affixed to the substrate using a connection component. Non-limiting examples of connection components include adhesives (for instance, temporary, permanent and/or weatherproof adhesives), hook and loop material and/or fasteners (for instance, Velcro® made by Velcro Industries B.V. of Onbekend, The Netherlands), tape (for instance, double-sided tape, high-bond double stick tape, or the like), hooks, snaps, hangers, or the like.

In general, the substrate layer 105 may operate as a carrier for the dimensional content 110, whereby the dimensional content may be affixed to the substrate layer for display from the surface 115 without having to be directly affixed to the surface. As such, the dimensional content 110 may be affixed using permanent materials without having to apply the permanent materials directly to the surface 115. The dimensional content 110 may be affixed to the surface 115 through the substrate layer 105 in a semi-permanent yet stable manner (for example, the dimensional content may not be unintentionally removable).

In some embodiments, a substrate content display system may be configured to be semi-permanent as they may be affixed to the surface 115 without using permanent materials required by conventional techniques. To remove the substrate content display system, the substrate layer 105 may be removed from the surface 115 along with the dimensional content 110. The substrate content display system may allow for the display of dimensional content 110 without the clean-up, maintenance, damage, and/or resources required by conventional techniques. Accordingly, a retailer may use a content display system configured according to some embodiments, such as a substrate content display system, to achieve a temporary advertising campaign using three-dimensional content while maintaining the removal costs associated with a conventional two-dimensional, window decal advertising installation.

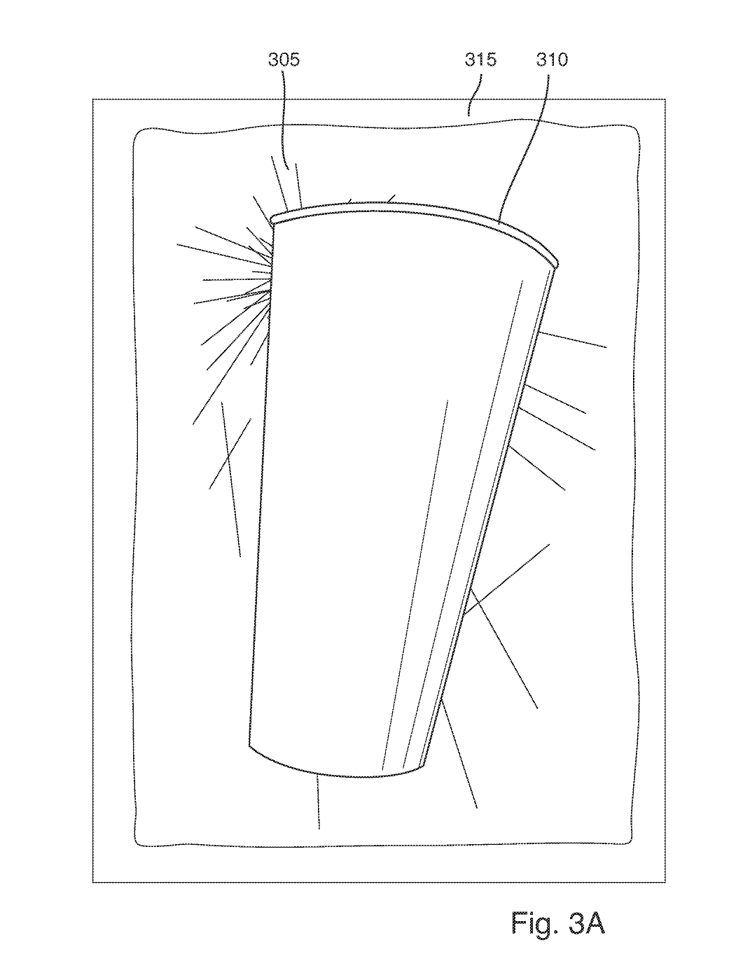

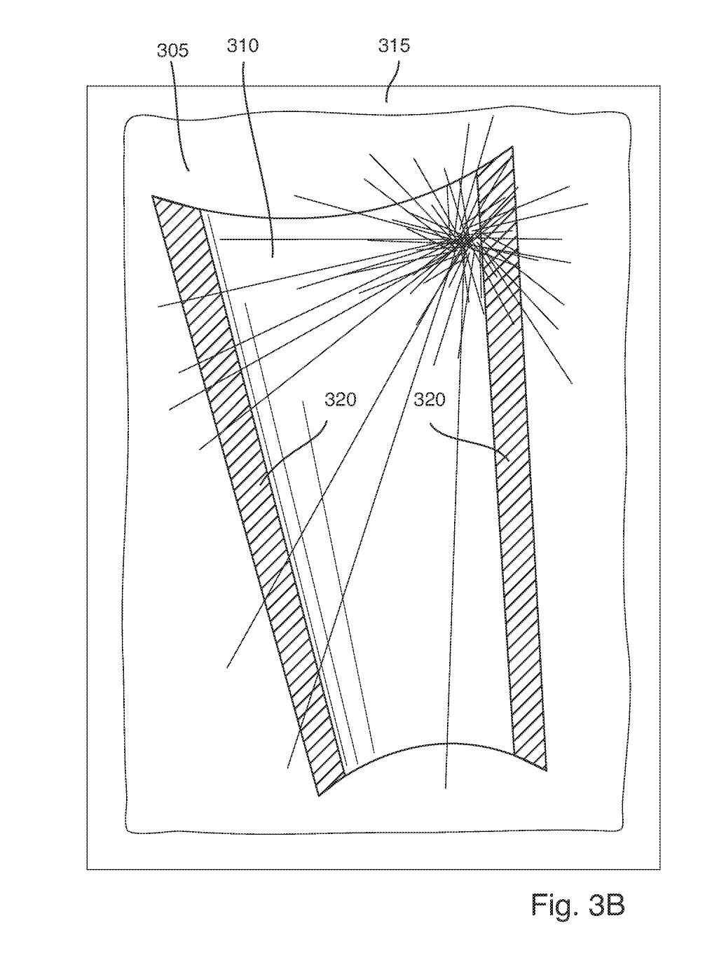

In some embodiments, the substrate layer 105 may include images, photographs, indicia, text, or other such graphics. In some embodiments, indicia may be included on the substrate layer 105 to indicate the position (for example, “targets”) of the dimensional content 110 on the substrate layer. In some embodiments, the substrate layer 105 may include graphics that correspond with the dimensional content 110 (see, for example, FIGS. 3A and 3B). For instance, the substrate content display system may be configured for display on a glass surface, the dimensional content 110 may be configured to appear as though it is an object projecting from the glass, and the substrate layer 105 may include graphics that appear as though the glass is broken (for instance, as though the object is breaking through the glass). In another example, the dimensional content 110 may include a 3D baseball and the substrate layer 105 be affixed to a wall and may include an image of a baseball bat, for instance, configured to appear as though it has just hit the baseball. In a further example, the dimensional content 110 may include a 3D beverage container and the substrate layer 105 may be affixed to an external concrete wall and may include images related to the beverage container and/or contents thereof, such as a fluid, a straw, ice, or the like. In yet a further example, the dimensional content 110 may include a 3D food product (for instance, a hamburger, French fries, or the like) and the substrate layer 105 may include an image of a person holding, eating, or otherwise interacting with the food.

In some embodiments, the dimensional content 110 and/or portions thereof may be configured to move, rotate, or otherwise exhibit motion. The motion may be induced by various means, including, without limitation, motors, wind, and/or user interaction.

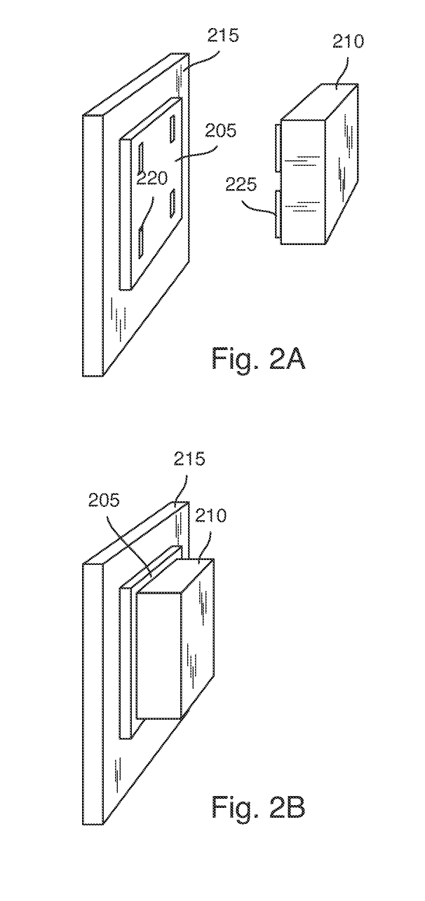

FIGS. 2A and 2B depict a side view of a substrate content display system according to some embodiments. A substrate content display system may include a substrate 205 and a dimensional content component 210. The substrate 205 may be affixed to a surface 215 according to some embodiments described herein. In FIG. 2A, the substrate 205 has been affixed to the surface 215 and the dimensional content component 210 has not been affixed to the substrate.

In some embodiments, the substrate 205 and/or the dimensional content component 210 may include fastening elements 220, 225. In some embodiments, the fastening elements 220,225 may be configured to affix the substrate 205 to the dimensional content component 210 and/or vice versa. In some embodiments, the fastening elements 220 may be configured to correspond with fastening elements 225. For instance, fastening elements 225 may be configured as a hook, and fastening elements 220 may be configured as a receiver for the hook. In another instance, fastening elements 220, 225 may be configured as corresponding components of a hook and loop fastener, buttons, snaps, double-stick tape, or the like. In some embodiments, the substrate 205 and/or the dimensional content component 210 may be affixed to each other using fastening elements 220, 225 in combination with adhesive materials. Embodiments are not limited to substrate content display systems that include fastening elements 220, 225, as the substrate 205 and/or the dimensional content component 210 may be affixed to each other using only adhesives.

FIGS. 3A and 3B depict a front view and a back view, respectively, of an illustrative substrate content display system. As shown in FIG. 3A, a substrate 305 is affixed to a glass surface 315. A dimensional content component 310 is affixed to the substrate. The overall impression of the substrate content display system provides a three-dimensional beverage container breaking through a glass window/door. FIG. 3B depicts a back view of the substrate content display system, including attachment regions 320 where the dimensional content component 310 is affixed to the substrate 305, for example, using permanent or semi-permanent adhesives.

A substrate content display system will be configured as a dimensional window graphic configured to provide a semi-permanent (removable) POP message on a glass window surface. The dimensional window graphic will be configured to interrupt the 2D window plane, thereby accentuating the product and/or message elements displayed thereon by presenting at least a portion of them in a 3D shape that mimics the actual shape of the product while maintaining solid contact to the glass window surface.

A removable-adhesive vinyl graphic will be applied to the window as a graphic. This graphic will be a window decal having images and indicia printed thereon. The window decal will include indicia configured to provide targets for attaching a dimensional content component (the “3D element”) using high-bond double stick tape. If attached to the window directly, the high-bond double stick tape would, when removed, damage the tint material used to tint the window and will leave behind a residue requiring extensive clean-up.

The 3D element will be formed from a 2 millimeter corrugated plastic material with adhesive flaps positioned on the left and right side that will have high-bond double stick tape arranged thereon. The 3D element will be attached to the window decal along both edges permanently with high-bond double-stick tape. The targets on the window decal will indicate where the edges should be attached. A first edge of the 3D element will be affixed to the window decal. The 3D element will be curved into a 3D shape by bending the 3D element against the resistance of the attachment point. Once the desired shape is achieved the second edge of the 3D element will be attached to the window decal.

The substrate content display system will be highly wind resistant and impact resistant. When the advertising campaign is over, the content display system may be taken down by removing (for example, peeling) the window decal from the window which also removes the attached 3D element. In this manner, removal of the content display system does not require the clean-up of excessive adhesive residue or surface damage to the window glass from the high-bond adhesive that would be necessary to secure a 3D element directly to glass.

Retail establishments and other buildings are often constructed from a wide array of materials, including brick, concrete, and glass. In addition, retail establishments often include or are adjacent to associated structures, such as signs, parking elements, lighting structures, or the like, that are also often formed from a wide array of materials. Some of the building materials and the associated structures are often at least partially formed from a metallic material. In particular, the metallic material may include ferrous materials (or “magnetic” materials) capable of attracting a magnet, such as iron, steel, nickel, combinations thereof, and/or alloys thereof.

Accordingly, some embodiments may include a content display system having a dimensional dement attached to at least one magnet element (a “magnetic content display system ”). The at least one magnet element may be magnetically attracted to the magnetic materials of a retail establishment or associated structure. The size and/or strength of the at least one magnet element may be selected such that the magnetic content display system may be removed from the magnetic material without causing damage to the magnetic material, yet the magnetic content display system may not be unintentionally removable (for instance, due to heat, wind, and/or incidental contact). In this manner, a dimensional element may be semi-permanently affixed to a retail establishment using existing structures and/or surfaces formed at least partially from magnetic materials. For example, a magnetic content display system may be affixed to the magnetic materials of an existing structure of a drive-through food ordering system of a restaurant (for instance, a “fast-food” restaurant).

The at least one magnet element may include any type of magnet known to those having ordinary skill in the art and may be formed in any shape, thickness, or other structural characteristic capable of operating according to some embodiments described herein. In some embodiments, the at least one magnetic element may include a magnetic sheet that may be affixed to dimensional content, for instance, using an adhesive and/or fastener. In some embodiments, the magnetic sheet may be rigid or semi-rigid. In some embodiments, the magnetic sheet may be flexible or semi-flexible. In some embodiments, the magnetic sheet may include a vinyl coated flexible magnetic sheet.

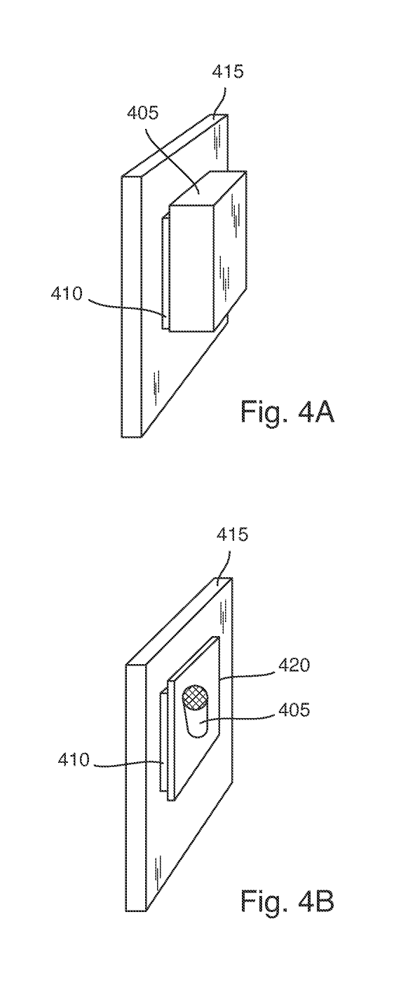

FIGS. 4A and 4B depict illustrative magnetic content display systems according to some embodiments. As shown in FIG. 4A, a magnetic element 410 may be affixed to dimensional content 405. The magnetic element 410 may be magnetically attracted to a magnetic material surface 415. The magnetic element 410 may have properties, such as size, shape and/or magnetic field characteristics, such that the magnetic element may be affixed to the magnetic material surface 415 and support the dimensional content 405. In FIG. 4B, dimensional content 405 may be affixed to a backing structure 420 and the backing structure may be affixed to the magnetic element 410. The backing structure 420 may include any material capable of supporting the dimensional content 405 and being affixed to the magnetic element 410, including, without limitation, plastic, metal, paper (for instance, cardboard), and/or wood. The dimensional content 405 may be affixed to the backing structure 420 using any adhesive or fastener capable of connecting the dimensional content to the support material, including screws, nails, staples, hooks, hook and loop fasteners, or the like.

A magnetic content display system may be configured in various shapes and/or sizes. For example, the magnetic content display system may have an area of about 1 meter (m), about 2 m, about 3 m, about 4 m, about 5 m, about 6 m, about 7 m, about 8 m, about 9 m2, about 10 m2, and values and ranges between any two of these values (including endpoints).

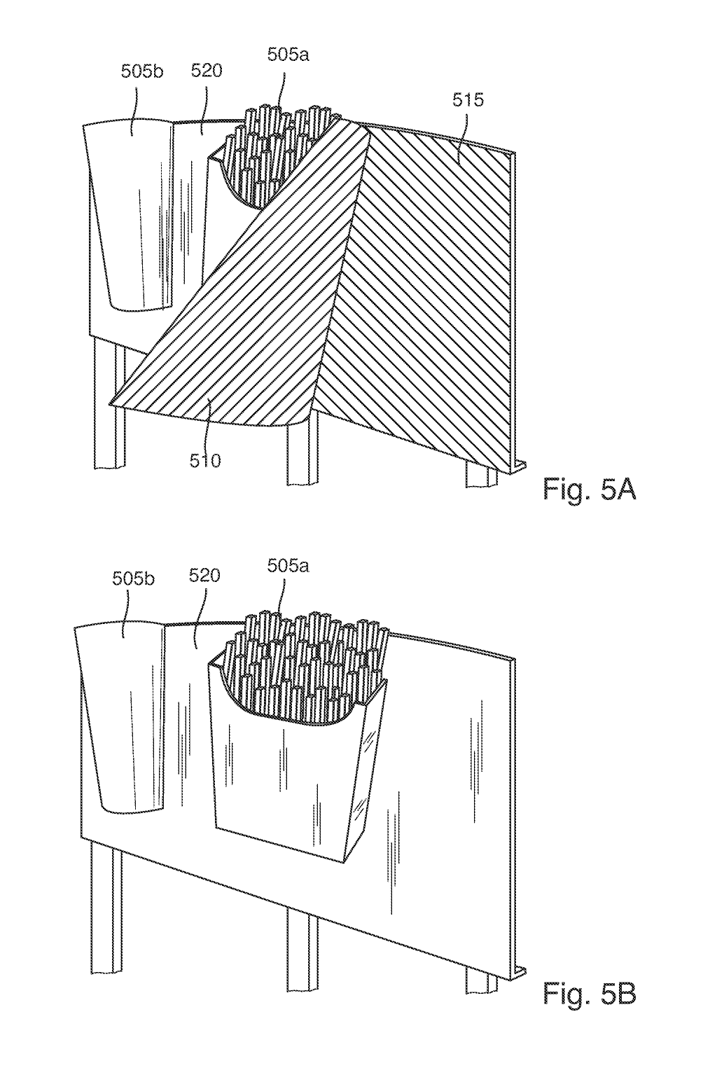

FIGS. 5A and 5B depict multiple views of an illustrative magnetic content display system according to a first embodiment. As shown in FIG. 5A, dimensional content 505a may be attached to a backing structure 520. For instance, the dimensional content 505a may be configured as a three-dimensional depiction of food and a food Container and may be formed from a paper-based material, such as corrugated cardboard. The dimensional content 505a may be attached to a backing structure 520, for instance, made from the same or similar material as the dimensional content and may include images, graphics, pictures, or the like related to the dimensional content. As shown in FIG. 5A, the back side of the backing structure 520 may be at least partially covered by a magnet element 510, such as a flexible magnetic material. The magnet element 510 may be configured to be attached to a magnetic material 515. FIG. 5B depicts a front view of the magnetic content display system supporting dimensional content 505a, 505b.

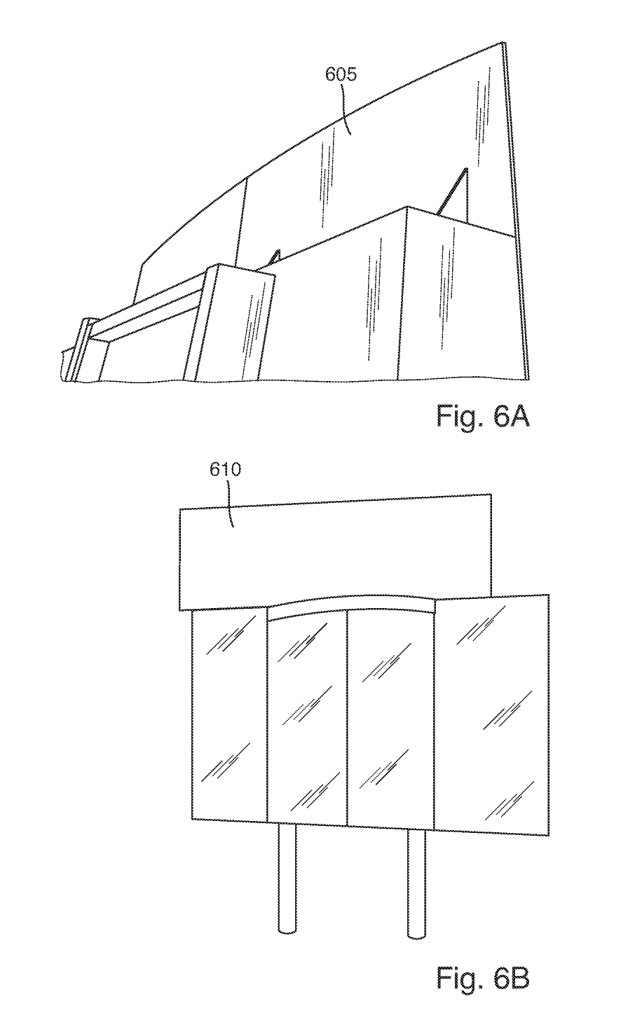

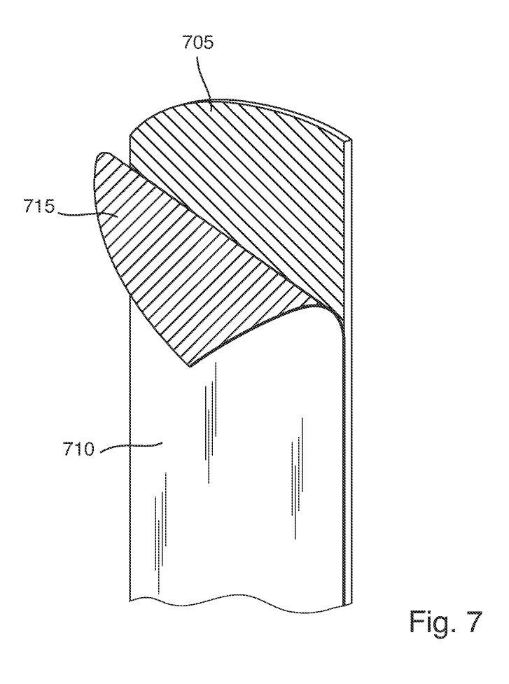

FIGS. 6A and 6B depict multiple views of an illustrative magnetic content display system according to a second embodiment. FIG. 6A depicts the back view of a magnetic content display system formed as a steel drive-thru topper blank 605. The steel drive-thru topper blank 605 may include a magnetic surface arranged on a component of a drive-through menu ordering system. The dimensional content 610 may include a magnetic element arranged on a back surface thereof that is capable of attaching the dimensional content to the magnetic surface of the steel drive-thru topper blank 605.

FIG. 7 depicts an illustrative magnetic content display system according to a third embodiment. As shown in FIG. 7, a magnetic content display system may include a magnetic material 705 associated, for example, with a lawn sign. A content element 710 may be configured to semi-permanently attach to the magnetic material 705, for instance, through a magnetic material 715 arranged on a side opposite the content (for instance, two-dimensional images, graphics, text, or the like) arranged on the content element. In an embodiment, the magnetic material 705 may include a flexible magnetic material.

Retail establishments and other buildings often include multiple projections, edifices, and associated elements, such as awnings, overhangs, window sills, or the like. In addition, retail establishments and other buildings are often adjacent or directly adjacent to various structures, including parking elements, lighting structures, ordering structures (for instance, drive-through ordering devices and associated signage for “fast-food” restaurants). Accordingly, some embodiments may include a support structure content display system having a dimensional element configured to attach to, hang from, or otherwise connect to at least one aspect of a building or associated structure. The support structure may be configured in any form capable of semi-permanently affixing dimensional content to a building or associated structure, including a bracket, a brace, a hook, a hanger, or the like. In this manner, the support structure content display system may be removed from the building or associated structure without causing damage thereto, yet the support structure content display system may not be unintentionally removable (for instance, due to heat, wind, and/or incidental contact). In this manner, a dimensional element may be semi-permanently affixed to a retail establishment using existing structures and/or surfaces without having to modify the structures and/or use permanent methods to affix the dimensional element.

In some embodiments, the support structure may be configured to attach to and/or rest on a particular building element or associated structure or particular types thereof.

For instance, the support structure may be configured to be affixed to an awning or window sill. In another instance, the support structure may be configured to be attached to and/or rest on the top of a menu display structure of a drive-through food ordering system. For instance, the support structure may be of sufficient weight to allow the support structure content display system to rest on a structure in a stable, semi-permanent manner that is not unintentionally removable. In some embodiments, the support structure may be configured to adjust to attach to multiple types of building elements or associated structures. In some embodiments, the support structure may include springs, coils, ropes, Straps, or other elements capable of providing tension, for example, to hold the support structure content display system and/or portions thereof in place.

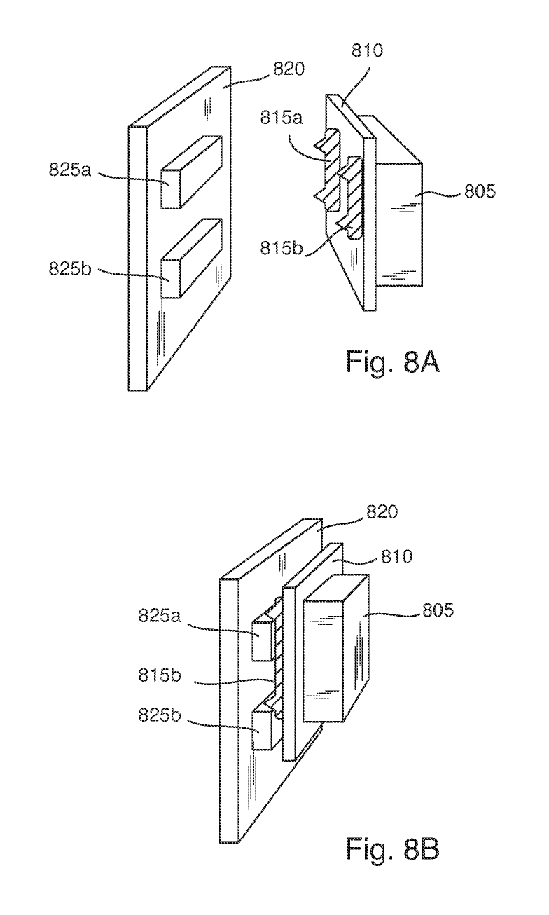

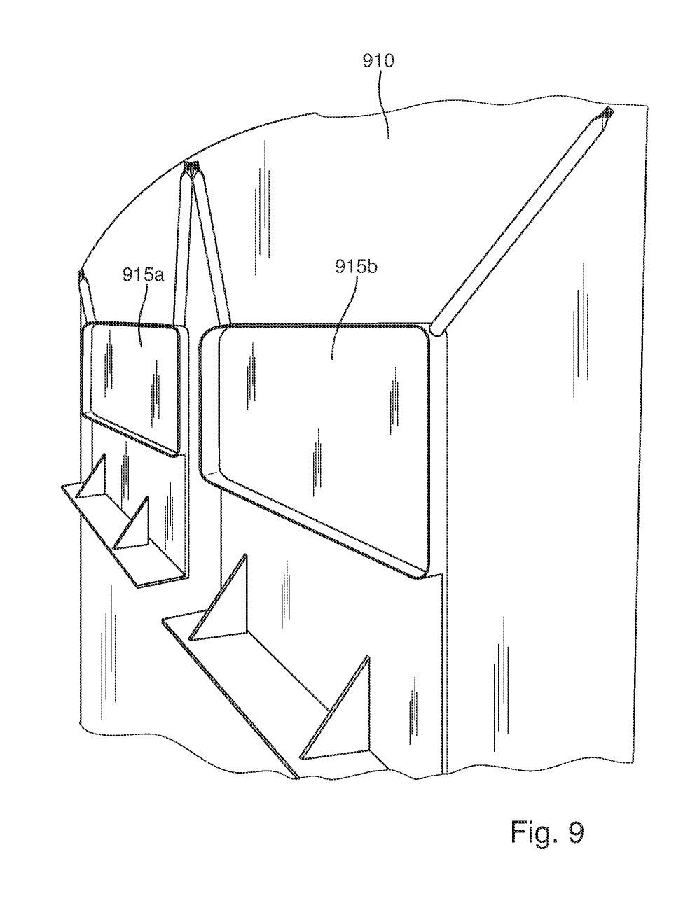

FIGS. 8A and 8B depict an illustrative support structure content display system according to an embodiment. As shown in FIG. 8A, dimensional content 805 may be attached to a backing structure 810. The backing structure 810 may be attached to support structures 815a, 815b. In some embodiments, the dimensional content 805 may not be attached to a backing structure 810 such that the support structures 815a, 815b may be attached directly to the dimensional content. A structure 820, such as a building or associated structure, may include elements 825a, 825b that may generally include any non-flat surface or top of a structure (for instance, elements that may receive a support structure 815a, 815b). In general, the elements 825a, 825b may include any element that the support structures 815a, 815b may be attached to or may be used to semi-permanently affix the dimensional content 805 to the structure 820 using the support structures. FIG. 8B depicts the support structure content display system semi-permanently affixed to the structure 820.

FIG. 9 depicts a back view of a support structure content display system according to an embodiment. As shown in FIG. 9, a backing structure 910 may have support structures 915a, 915b attached using various attachment methods, such as adhesives and/or fasteners. The front of the backing structure 910 may have dimensional content attached thereto. The support structures 915a, 915b may be configured to attach the support structure content display system to and/or allow the support structure content display system to rest on various structures, such as signage, display devices and/or ordering devices associated with a drive-through food ordering system.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by embodiments described herein.

1. A content display system comprising:
a substrate configured to be temporarily affixed to a surface; and
a dimensional content component configured to be permanently or semi-permanently affixed to the substrate.

2. The system of claim 1, wherein the substrate is configured as a window decal.

3. The system of claim 1, wherein a temporary adhesive is arranged on an adhesive surface of the substrate to affix the substrate to the surface.

4. The system of claim 1, wherein the dimensional content component is affixed to the substrate using a permanent adhesive.

5. The system of claim 1, wherein the dimensional content component is configured as a three-dimensional advertisement.

6. The system of claim 1, wherein the system is configured as an advertisement display of a temporary advertising installation.

7. A magnetic content display system comprising:
a dimensional content component attached to at least one magnetic element.

8. The system of claim 7, wherein the at least one magnetic element comprises a flexible magnetic material.

9. The system of claim 7, wherein the dimensional content component is configured as a three-dimensional advertisement.

10. A support structure content display system comprising:
a dimensional content component attached to at least one support structure, the at least one support structure being configured to be attached to at least one element of a structure.

11. The system of claim 9, wherein the at least one element of a structure comprises an element of a drive-through food ordering system.

12. The system of claim 10, wherein the dimensional content component is configured as a three-dimensional advertisement.
